(19) United States
(12) Patent Application Publication
(10) Pub. No.: US 2006/0152525 A1
(43) Pub. Date: Jul. 13, 2006

(54) Viewing screen color limiting device and method

(76) Inventor: Kenneth M. Woog, Lake Forest, CA (US)

Correspondence Address: Donald W. Meeker;Patent Agent, 924 East Ocean Front #E, Newport Beach, CA, 92661, US

(21) Appl. No.: 11/035,181

(22) Filed: Jan. 13, 2005

(51) Int. Cl. G09G 5/02

(52) U.S. Cl. 345/589

(57) ABSTRACT

A timed programmable control alters signals between an electronic device and a viewing screen to lower or eliminate a signal for a specific color on the screen at specific times. Eliminating or lowering blue color on the screen allows normal production of melatonin prior to normal sleep times to permit normal sleep cycles. The control may be a microcontroller or simple switch inside a locked box, a video card, or software to control light pixel values in memory, VGA signals, and digital to analog conversions.

### BACKGROUND OF THE INVENTION

1. Field of the Invention

The present invention relates to control devices for display screens, and particularly to a viewing screen control device and method which controls the input signal to the viewing screen using a locking timer device that limits a user's exposure to the blue light radiated from the display screen during nighttime usage, thereby protecting the ability of the user's body to create melatonin and providing a parental-control lock for the timed control of the viewing screen.

2. Description of the Prior Art

The circadian system controls typical biological functions of plants and animals and reoccurs at approximately 24-hour intervals. In humans, the body's clock is located in the suprachiasmatic nucleus (SCN), a distinct group of cells found within the hypothalamus. The SCN controls or coordinates the circadian rhythm in the human body. Typically, a human's circadian rhythm is calibrated by the alternation of light through the eyes and darkness via melatonin secretion by the pineal gland.

An article about Japanese researchers determined that bright computer displays used in the evening (to play games) would reduce the melatonin levels produced naturally in the body of their subjects. Melatonin is the hormone that helps regulate day/night sleep cycles and when produced in the evening help us the feel tired. This explained an observation made of the children seen in clinical work. These children, when on the computer late at night playing computer games, never seemed to tire and would stay up late, often later than their parents would allow. This resulted in troubles functioning the next day, getting up in the morning and getting to school. Their sleep cycles had been disturbed.

Bio-Psychological and anatomical research show that there are specific retinal ganglion cells sensitive to blue light in the 464-484 nanometer range with axons that connect to the SCN. The cells in the retina provide the feedback to the brain regarding day/night to regulate and time melatonin production. This suggests that the dimming of the display need be done primarily with the blue levels on the display. This is important because most computer displays provide a convenient way to dim or brighten the display. Children, when faced with a dim display might simply turn up the brightness, which would defeat the invention. By mostly dimming the blue levels, the overall brightness would be maintained to a usable level. While the display would appear tinted, it could not be easily adjusted to compensate for the color change. Thus automatically lowering the blue levels at a specific time in the evening (say after 7pm) would allow the body to produce melatonin and the user's sleep cycle would not be altered.

Prior art systems do not adequately address this problem.

U.S. Patent Application #20040155854, published Aug. 12, 2004 by Ma, illustrates methods, apparatus, systems, and articles of manufacture for gradually dimming backlit displays. The backlit displays may be gradually dimmed by reducing a level of the backlighting from an initial level to a final level in a plurality of steps over a dimming interval. The gradual dimming operations may be performed by any suitable combination of software and hardware components. For some embodiments, parameters used for the dimming, such as the dimming interval and final level of the backlighting, may be specified by a user.

U.S. Pat. No. 6,313,878, issued Nov. 6, 2001 to Jankowiak, indicates a method and structure for providing an automatic hardware-implemented screen-saver function for a display product. The hardware-implemented screen-saver prevents burn-in of an image displayed on a screen of a display product by automatically reducing the video gain, and therefore the contrast, of the image when the portion of the image within a two-dimensional detection window has changed by less than a predetermined amount for a predetermined period of time. A lack of change of the incoming video signal of the image is detected and used to invoke a reduction in contrast of the image displayed on the display product. This allows the image to remain visible, yet reduces the possibility of burn-in of the image in the screen of the display product.

U.S. Pat. No. 4,722,005, issued Jan. 26, 1988 to Ledenbach, puts forth a software controllable hardware CRT dimmer for controlling a video display on a viewing screen such that it will not burn in the screen when the image is left unchanged for a prolonged period of time. The software controlled dimming circuit implements a shifting operation to the digital signal when activated. The shifting results in a lowering of intensity of the screen, yet retaining the original image on the screen.

U.S. Pat. No. 6,443,977, issued Sep. 3, 2002 to Jaillet, concerns an apparatus and method for selectively stimulating cortical brain activity of a patient with hemispheric brain differences using light and/or sound includes exposing the patient to one or more lights placed in close proximity to a patient's eyes wherein the one or more of lights selectively stimulate the non-dominant eye connected to the non-dominant cerebral hemisphere. Another application of the technology is with computer monitors and televisions. This embodiment encompasses one or more oscillating lights set-up in a proscribed manner on a person's computer monitor. The light pattern of the present invention may be displayed in a subliminal alternating checkerboard pattern that would be set to the individual user. In one embodiment, the light will stimulate the non-dominant cerebral hemisphere greater than the dominant cerebral hemisphere. In this version, the non-dominant cerebral hemisphere is stimulated to a greater degree than the dominant cerebral hemisphere. It is the coordinated stimulation of the non-dominant hemisphere that helps create a balance of integration of excitatory post synaptic potentials (EPSP).

U.S. Pat. No. 6,299,632, issued Oct. 9, 2001 to Jaillet, illustrates, an apparatus and method for selectively stimulating cortical brain activity of the non-dominant hemisphere using light and/or sound, comprising a surface placed in close proximity to a patient's eyes and a plurality of lights disposed on the surface wherein the plurality of lights selectively stimulate the non-dominant eye connected to the non-dominant cerebral hemisphere. Another application of the technology is with computer monitors and televisions. This would encompass either an oscillating or plurality of lights set up in a prescribed manner on a person's computer monitor. The light pattern of the present invention could be displayed in a subliminal alternating checkerboard pattern that would be set to the individual user. This will stimulate the non-dominant cerebral hemisphere greater than the dominant cerebral hemisphere.

U.S. Patent Application #20030193842, published Oct. 16, 2003 by Harrison, is for a time display device (“TDD”) equally adaptable to watches, clocks, computers, phones, and vehicles, which indicates the current hour of the day by displaying a color that refers an observer to the disclosed color-to-hour matrix, thereby eliminating the traditional hour hand or digit altogether. In an alternate embodiment, the time display device includes an electronic, full-color, flat-panel video display. As in the flat-panel display of a conventional digital watch or computer monitor, the depicted flat-panel display displays hour information as kept by a timekeeping mechanism inside the TDD. However, instead of displaying a numerical digit or digits (e.g., “1”) to indicate the active hour, this hour indicator displays only a color, specifically, the color corresponding to the active hour according to the color-to-hour matrix; in other words, the hour indicator displays a single graphical image that takes up the entire height and width of the display area, and this single image is essentially of a single color.

U.S. Pat. No. 6,506,148, issued Jan. 14, 2003 to Loos, discloses nervous system manipulation by electromagnetic fields from monitors. Physiological effects have been observed in a human subject in response to stimulation of the skin with weak electromagnetic fields that are pulsed with certain frequencies near ½ Hz or 2.4 Hz, such as to excite a sensory resonance. Many computer monitors and TV tubes, when displaying pulsed images, emit pulsed electromagnetic fields of sufficient amplitudes to cause such excitation. It is therefore possible to manipulate the nervous system of a subject by pulsing images displayed on a nearby computer monitor or TV set. For the latter, the image pulsing may be imbedded in the program material, or it may be overlaid by modulating a video stream, either as an RF signal or as a video signal. The image displayed on a computer monitor may be pulsed effectively by a simple computer program. For certain monitors, pulsed electromagnetic fields capable of exciting sensory resonances in nearby subjects may be generated even as the displayed images are pulsed with subliminal intensity.

U.S. Patent Application #20020041280, published Apr. 11, 2002 by Woo, shows an apparatus and a method for reducing power consumption of a LCD (Liquid Crystal Display) backlight lamp that includes a power unit supplying power, a control unit being supplied power from the power unit and outputting a brightness control information signal by incremental levels, a key input unit having adjustment keys for adjusting a brightness of a LCD screen, a memory unit storing a control information signal inputted from the control unit, an inverter unit being inputted the brightness control information signal by levels from the control unit and outputting power of a backlight lamp by corresponding incremental levels, and a backlight lamp being driven by the power output from the inverter unit. The apparatus and method are capable of reducing unnecessary power consumption by increasing the power to drive the backlight lamp gradually so as to be similar to an actual brightness increase curve of a backlight lamp in the consideration of luminescent characteristics of the backlight lamp and then supplying a constant preset power level after finishing a starting operation of the backlight lamp.

No prior art is known for timed color dimming of the display. There are software screen-saver applications which turn off the display or change the display altogether to reduce problems related to phosphor burn on CRTs. These applications generally time inactivity assuming the user is no longer operating the computer. When the computer mouse or keyboard has not been used for a preset amount of time, the application alters the display by blanking it or displaying an image that moves around on the screen. Upon detection of keyboard or mouse activity, the application either restores the display or prompts the user for a password before restoring the user's display.

What is needed is a system and method for limiting or eliminating the blue levels on a viewing screen or display prior to normal sleep times so that the normal melatonin production is not altered, while maintaining the overall brightness at a usable level. While the display would appear tinted, it could not be be easily adjusted to compensate for the color change. Automatically lowering or eliminating the blue levels at a specific time in the evening (say after 7pm) would allow the body to produce melatonin and the user's sleep cycle would not be altered.

### SUMMARY OF THE INVENTION

An object of the present invention is to provide a system and method that dims or lowers the brightness of certain colors of a computer display or other viewing screen at preset times such as dimming or eliminating the blue levels to allow evening use of the computer yet limit the harmful effects of the blue light display on the user's own body's production of the hormone melatonin.

A further object of the present invention is to provide a programmable display dimming system which is locked onto the hardware and is highly secure so that it cannot be hacked, deleted, or overridden.

Another object of the present invention is to provide a system with a standard hardware attachment and program that works with any operating system.

One more object of the present invention is to provide a system which controls only the input to a display screen and does not interfere with any operating system function or any application.

A related object of the present invention is to provide a system that does not interfere with any hardware function or feature (except to enforce security features) by enclosing standard connectors inside a physically locked box.

An alternate object of the present invention is to provide a simple version of the device that simply provides a manual switching mechanism to allow controlling the video output with lockable key switch to directly switch the video signals and two locks, one to lock access to the set screws and one to switch the video signals, to create a very inexpensive method of providing parental control over computer use.

A related object of the present invention, rather than connecting through the keyboard port, the device uses the USB port and a USB keyboard or alternately contains its own keypad for entry of password information and a display that could display the time remaining and setup and configuration information as it is being entered for an independently controlled device.

Another alternate object of the present invention is to provide a control incorporated into a video card or system board for a software only solution which acts as a video device driver for the video display.

Another object of the present invention is to incorporate video limiting or switching features in the monitor/display and control provided by signals from the output electronic device.

A related object of the present invention is to incorporate video controlling features in the monitor/display at the input to the monitor/display for a control that is separate from the output electronic device.

A further alternate object of the present invention, in a flat panel display consisting of a controller IC connected to the input ports and the LCD panel including a microcontroller connected with a keypad and a flat panel controller with an on screen display character generator, is for the present invention to provide a real time clock IC (RTC) with a backup battery added to the flat panel and the microcontroller routines can be changed to incorporate both password security features for parental control and determine whether or not the display should be dimmed, wherein the Microcontroller can reconfigure the settings of the color gain values within the SAA6703 controller so that the blue levels can be lowered after a certain time in the evening.

Another alternate object of the present invention is to provide other possible methods of dimming a blue light in a display using software methods which involve changes to the device drivers or operating system to intercept or alter display pixel values to lower the blue content by identifying all places in software where the actual values are being written to the display memory or memory control hardware and inserting a program.

In brief, the invention comprises a device and method for controlling a display screen signal by using locked hardware or code protected programming of software to limit (attenuate by dimming) or eliminate (switch off) a specific color or colors, especially blue, from an electronic device output signal to a viewing screen during user hours preceding normal sleep time so that the natural production of melatonin (which induces sleep) by the body of the user is not adversely affected.

The hardware embodiment of the present invention provides a small enclosure including the necessary control circuitry that plugs into the VGA output port on a personal computer or other electronic device with a viewing screen. The screws that secure the mechanical mounting of the VGA port are only accessible when the lid of the enclosure is removed. Once the viewing screen output signal control device is attached to the personal computer, the lid is locked in place with a mechanical key lock. The viewing screen output control device cannot be removed from the computer without first removing the lid which requires the proper key.

There are two wire cables that exit the case of the invention. One cable is terminated with a female PS/2 keyboard socket. This allows the keyboard to be plugged into the invention. The second cable ends with a male PS/2 keyboard plug. This plug is designed to connect to the computer's keyboard input jack. The purpose of connecting to the keyboard is that it allows the entry of installation/configuration data and login user selection and password. Connection to the keyboard port of the personal computer also serves to provide operating power to the invention.

The invention contains its own microcontroller to provide a real time clock, memory and the operating program to keep track of user passwords and privileges. A backup battery supplies operating power to the clock when the computer is powered off. Video switching circuitry controlled by the microcontroller provides analog switching and attenuation of the video signals.

Setup is accomplished by running a word processor/text editor on the PC and then entering a unique key sequence on the keyboard. The invention then sends keyboard codes to the PC which will be received and displayed by the word processor (i.e. Wordpad) as menus and status displays. Keys pressed on the keyboard are received by the invention and provide input to the setup and password functions.

An alternate embodiment of the present invention provides a simple version of the device that uses a manual switching mechanism to allow controlling the video output. A lockable key switch is used to directly switch the video signals. The unit has two locks, one to lock access to the set screws and one to switch the video signals. This is a very inexpensive method of providing parental control over computer use.

Rather than connect through the keyboard port, the device uses the USB port and a USB keyboard or alternately contains its own keypad for entry of password information and a display that could display the time remaining and setup and configuration information as it is being entered.

While the present invention may incorporate external hardware to perform video signal control, an alternate embodiment of the control is incorporated on a video card or system board. A software only solution may act as a video device driver for the video display. Alternatively, these video controlling features could be incorporated in the monitor/display.

An advantage of the present invention is that it provides a system for allowing reasonable viewing of a display, such as a computer viewing screen, at any time of day or evening without altering the normal production of melatonin so that it does not disturb the natural sleep cycle of a user.

A further advantage of the present invention is that it cannot be hacked, deleted, or overridden.

Another advantage of the present invention is that it works with any operating system.

One more advantage of the present invention is that it does not interfere with any operating system function or any application.

A related advantage of the present invention is that it does not interfere with any hardware function or feature except to provide color limiting.

Yet another advantage of the present invention is that there is no software to install.

A still further advantage of the present invention is that it provides a simple version of the device that is an inexpensive method of providing color limiting.

Another advantage of the present invention is that it may contain its own keypad for entry of password and setup information and a display that could display setup and configuration information as it is being entered for an independently controlled device.

Another alternate advantage of the present invention is that it provides a software only solution which acts as a video device driver for the video display.

A further advantage of the present invention is that it provides an alternate viewing display control connected to the viewing display separate from the output electronic device.

A still further advantage of the present invention is that it can be setup/configured for use by the dealer/retailer prior to shipment to allow use by novice computer users with no user installation required and that it is also easy to install by an average computer user on an existing computer with very little instruction necessary.

One more advantage of the present invention is that it can be incorporated in a flat screen display or CRT monitor.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view of the lock box of the invention with connections to the computer ports, the viewing screen, and the keyboard;

FIG. 2 is a diagrammatic view of the lock box of the invention showing the central processing unit, clock and set screws;

FIG. 3 is a diagrammatic view showing the functional components of the invention with a large reduction in the blue light transmission between the VGA input and the VGA output;

FIG. 4 is a diagrammatic view showing an inexpensive simplified version of the invention with a manual switching mechanism housed within a locked container;

FIG. 5 is a diagrammatic view showing the functional components of the simplified version of the invention with a large reduction in the blue light transmission between the VGA input and the VGA output;

FIG. 6 is a diagrammatic flow diagram view showing the operational steps of a software embodiment of the present invention to reduce the blue light by changing the digital to analog conversion signals;

FIG. 7 is a diagrammatic view of an embodiment of the present invention used to control the light in a flat panel display;

FIG. 8 is a diagrammatic flow diagram view of the operation of the flat panel embodiment of FIG. 7;

FIG. 9 is a diagrammatic view of an embodiment of the present invention wherein the Operating System signals to the flat panel display to control the light in a flat panel display;

FIG. 10 is a diagrammatic flow diagram view of the operation of the flat panel embodiment of FIG. 9;

FIG. 11 is a diagrammatic flow diagram view showing the operational steps of another software embodiment of the present invention for dimming a blue light in a display by making changes to the device drivers or operating system to intercept or alter display pixel values to lower the blue content by identifying all places in software where the actual values are being written to the display memory or memory control hardware and inserting a program.

### BEST MODE FOR CARRYING OUT THE INVENTION

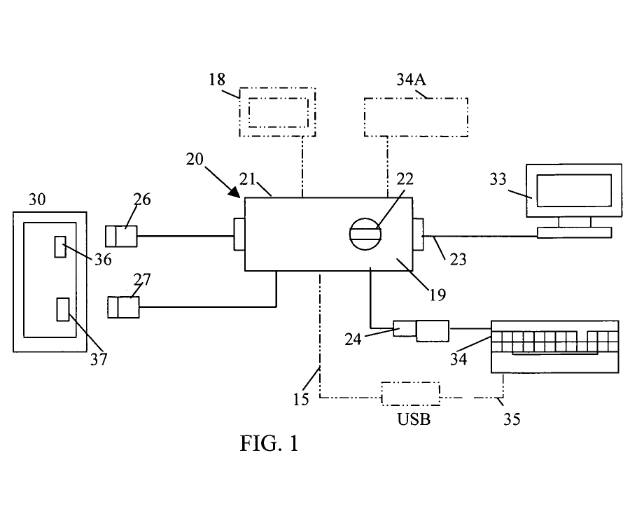

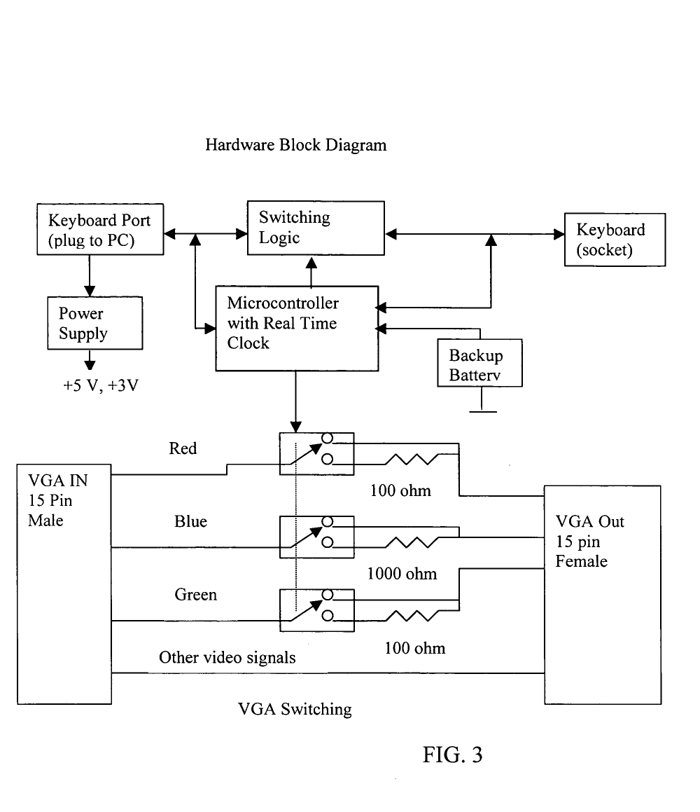

In FIGS. 1-3, a viewing screen control device 20 comprises a means for controlling a signal from an electronic device 30 to a viewing screen 33 to control display levels of the viewing screen by limiting specific colors that affect human sleep patterns. To maintain proper levels of melatonin important for sleeping, the means for controlling the signal preferably comprises a blue color limiting means.

The means for controlling the signal to the viewing screen may comprise a means for switching the signal for blue light off and on or attenuating the signal to lower the level of blue light on the viewing screen.

A means for controlling timing of the means for controlling the signal to the viewing screen enables turning on the control to stop or limit blue light when the melatonin levels are important such as several hours before normal sleep time and turn on the blue light to normal balanced color screen viewing levels at other times.

In FIGS. 1-3, the means for controlling the signal to the viewing screen comprises a programmable signal controlling circuitry 25, such as a microcontroller with a real time clock, within a locked container 21 secured to the electronic device or the viewing screen, the signal controlling circuit 25 programmed for altering the signal to eliminate blue light at the important melatonin producing times. An input connection 26 to the microcontroller 25 is made from the electronic device 30 and an output connection 23 is made from the microcontroller to the viewing screen 33 to enable the microcontroller to alter the signal to lower or eliminate blue light transmissions to the viewing screen at desired times for maintaining proper user melatonin levels.

In FIG. 1, the signals are video signals from a computer 30 through a VGA output port 36 connectable to the viewing screen and the programmable signal controlling circuitry comprises a video switching circuitry controlled by the microcontroller 25 to provide analog switching and attenuation of the video signals. The control circuitry is plugged into the VGA output port with a screw plug connection 26 housed within a closed box 21 with a lock 22 on the lid 19.

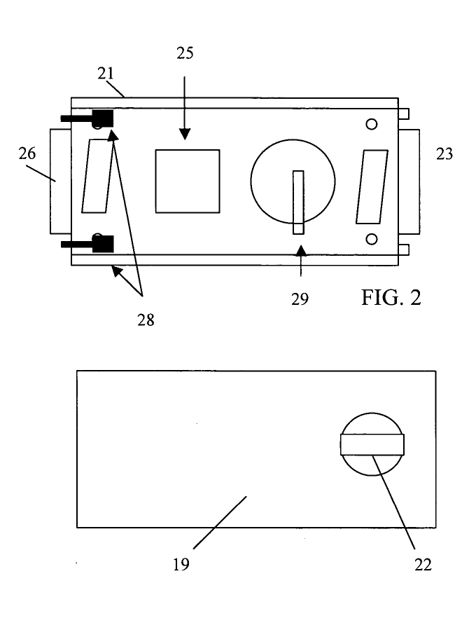

As shown in FIG. 2, the box 21 is attachable by internal set screws 28 within the box 21. After the lid 19 is closed and secured by a lock 22, which may be a key operated lock with the key in the possession of a parent or guardian helping a child computer user to maintain normal sleeping hours, the control circuitry may not be removed.

A connection 24 to the keyboard 34 allows entry of installation and configuration data and login user selection and password and also provides operating power to the viewing screen control device 20. Alternately with a computer having a keyboard with a USB keyboard connection 35 and the viewing screen control device 20 may use a USB port connection 15 to connect to the keyboard to allow entry of installation and configuration data and login user selection and password.

The viewing screen control device 20 may alternately further comprise a keypad 34A for entry of password information and a display 18 to display time remaining and setup and configuration information as it is being entered.

The microcontroller 25 uses a real time clock built-in clock for controlling timing of the viewing screen control device, a memory device, and an operating program to keep track of user passwords and privileges. A backup battery 29, such as a button cell battery, may be used to supply operating power to the clock.

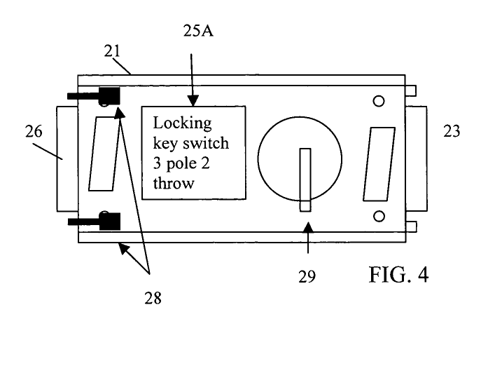

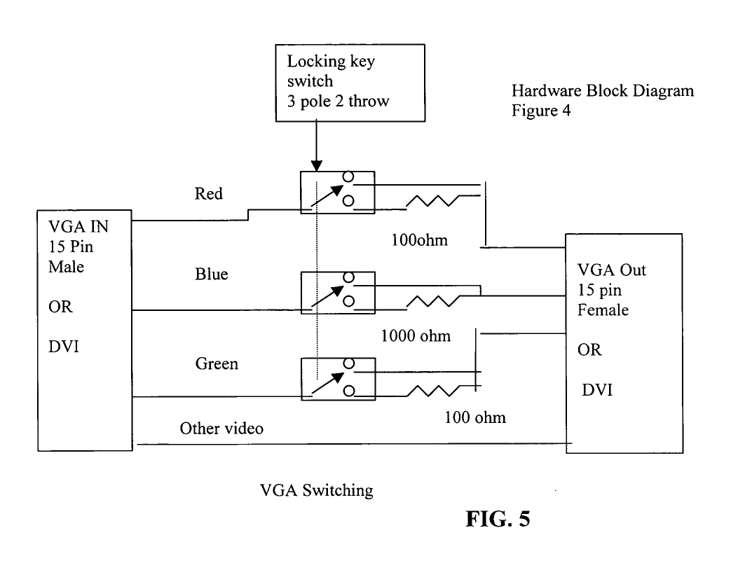

In FIG. 4 showing an inexpensive simplified version, the means for controlling the signal 20A comprises a manual switching mechanism 14 to allow controlling the signal, the manual switching mechanism may comprise a lockable key switch housed within a locked container 21A.

When the signal is a video signal, the means for controlling the signal may comprises a video card inside the electronic device or inside the visual display controls, when the viewing screen includes differential color controls, to act as a video device driver for the video display to selectively dim blue light at desired time intervals.

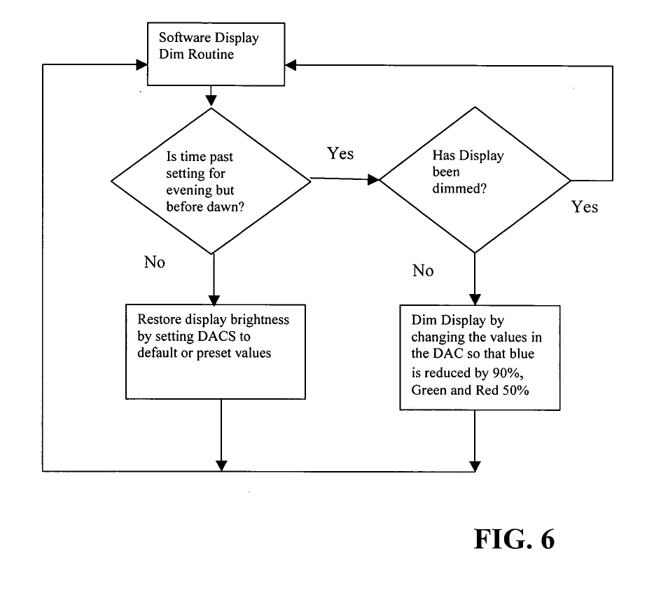

When existing video display controllers contain integrated or external digital to analog converters that convert the binary values of color levels to analog levels output on a VGA or an analog section of a DVI connector and the digital to analog converters contain high speed memory devices for a color palette that can quickly and without glitching translate values, the present invention comprises software to alter the memory to change the analog signal levels that are output for each digital value input by changing the values in the digital to analog converters to output lower analog signal levels for blue light as indicated by the flow chart in FIG. 6.

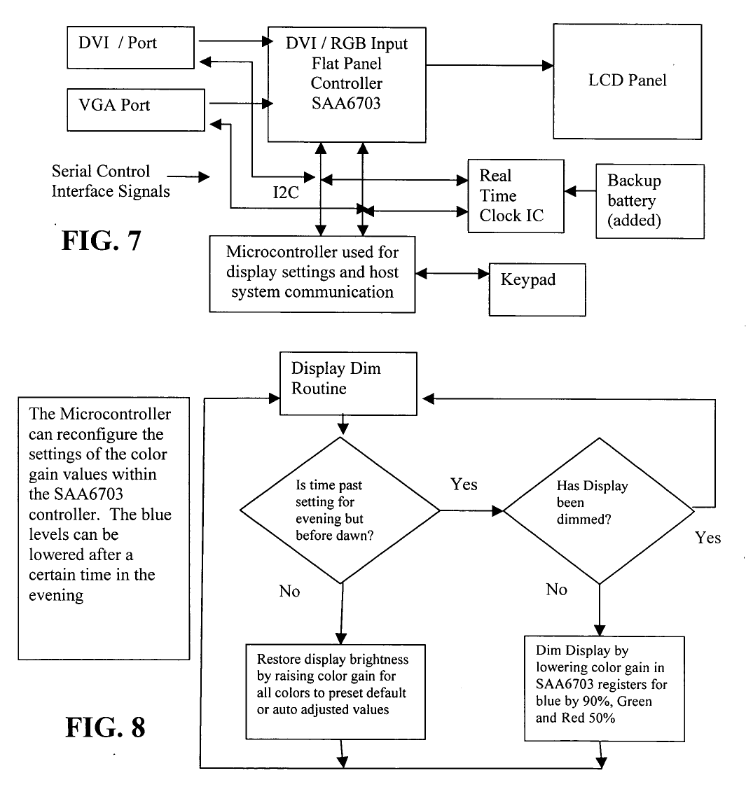

When the viewing screen comprises a flat panel display consisting of a controller IC connected to the input ports and the LCD panel includes a microprocessormicrocontroller connected with a keypad and a flat panel controller with an on screen display character generator as shown in FIG. 7, the present invention comprises a real time clock IC (RTC) with a backup battery added to the flat panel, and microcontroller routines, as shown in the flow diagram of FIG. 8, to incorporate both password security features for parental control and to determine whether or not the display should be dimmed and reconfiguring settings of color gain values to lower blue light levels after a certain time in the evening.

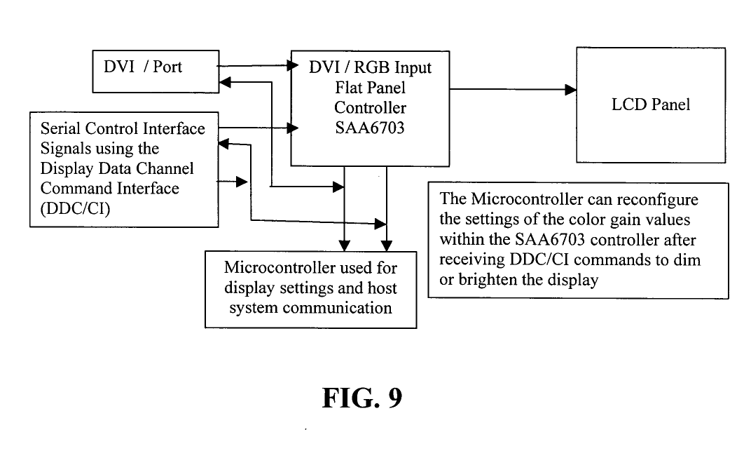

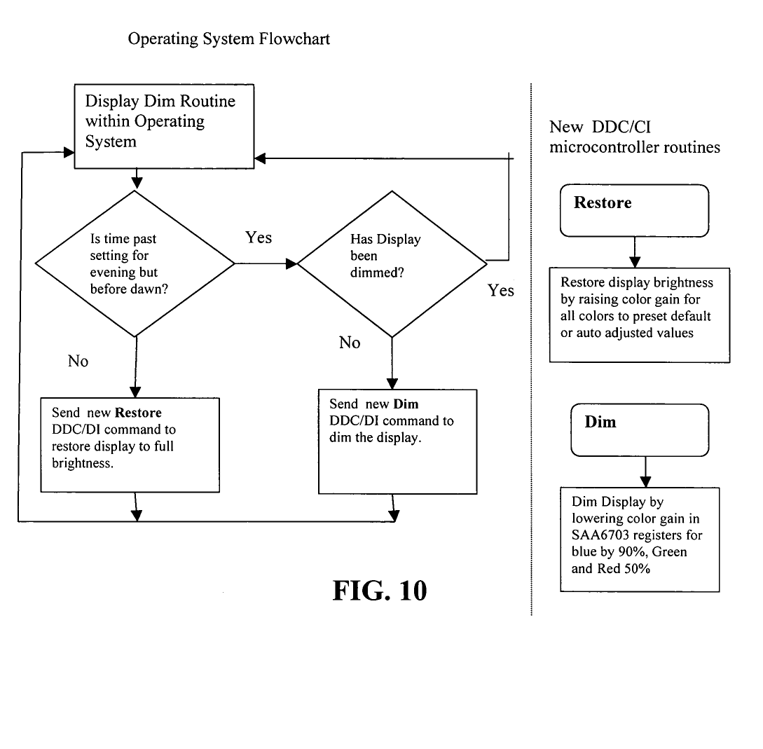

When the viewing screen comprises a flat panel display consisting of a display controller IC connected to the input ports and the LCD panel includes a microcontroller connected to the Serial Control Interface of the input ports as shown in FIG. 9, the present invention includes new functions supported by the Operating System shown in the flow diagram of FIG. 10 to determine whether or not the display should be dimmed, the sending of commands to the display through an appropriate Operating System interface such as the VESA Data Display Channel Command Interface (DDC/DI), and the reconfiguring of settings of color gain values in the display controller IC to raise or lower blue light levels by the microcontroller after receiving these commands.

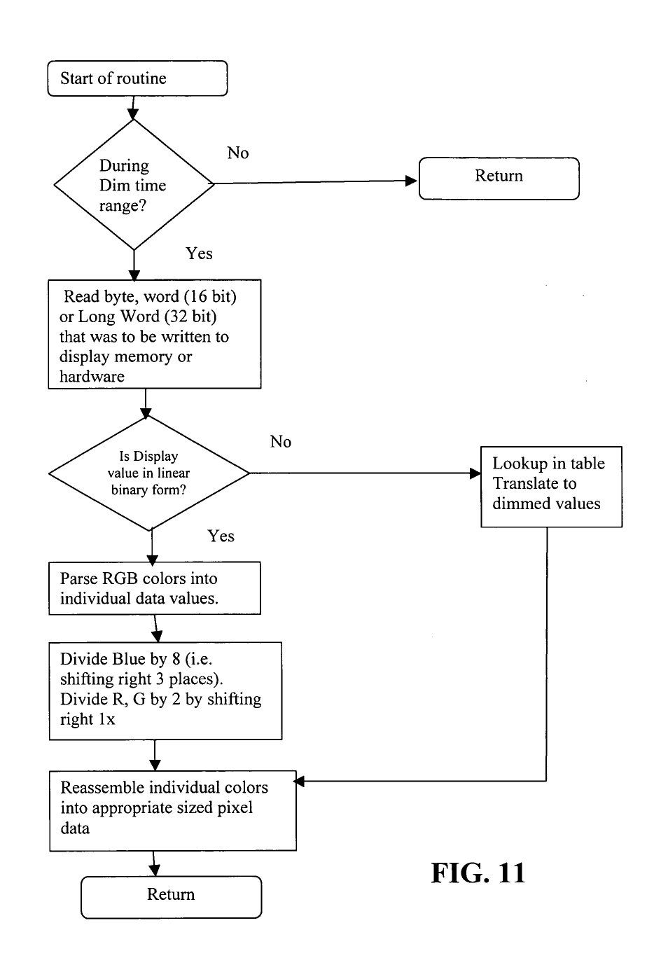

In FIG. 11, the viewing screen control device comprises a software program to change device drivers or an operating system to intercept or alter display pixel values to lower the blue content by identifying all places in software where actual values are written to a display memory or memory control hardware.

In practice, a viewing screen control method comprises the step of controlling a signal from an electronic device 30 to a viewing screen 33 to alter display levels of the viewing screen by limiting at least one color on the viewing screen that affects human sleep patterns, preferably limiting a blue color to allow normal production of melatonin by a user.

Controlling the signal may comprise switching the blue light signal on and off or attenuating the signal to minimize blue light levels prior to normal sleep time and normalize blue light levels at other times by activating a timing of the means for controlling the signal.

A programmable signal controlling circuitry 25, such as a microcontroller with a real time clock, is installed within a locked container 21 secured to the electronic device 30 or the viewing screen 33 and using the signal controlling circuit to alter the signal.

An input connection 26 to the microcontroller 25 is made from the electronic device 30 and an output connection 23 is made from the microcontroller to the viewing screen 33 to enable the microcontroller to alter the signal to lower or eliminate blue light transmissions to the viewing screen at desired times for maintaining proper user melatonin levels.

When the signals are video signals and the programmable signal controlling circuitry comprises a video switching circuitry controlled by a microcontroller 25, the step of controlling the signal comprises providing analog switching and attenuation of the video signals using the video switching circuitry.

When the electronic device 30 has a VGA output port 36 connectable to the viewing screen 33, the step of controlling the signal further comprises plugging the control circuitry into the VGA output port with a plug connection 26 and housing the screw plug connection within a closed box 21 with a locked lid 19.

When the electronic device is a computer having a keyboard 34, the step of controlling the signal further comprises making a connection 24 to the keyboard 34 and entering installation and configuration data and login user selection and password via the keyboard and providing operating power from the keyboard.

When the electronic device is a computer 30 having a USB connection 35 from the keyboard, the step of controlling the signal further comprises connecting a USB plug 15 form the microcontroller 25 to interact with the keyboard and entering installation and configuration data and login user selection and password via the keyboard 34.

When the device 20 further comprises an interconnected keypad 34A and monitoring display 18, the step of controlling the signal further comprises using the keypad 34A for entry of password information and monitoring the monitoring display 18 to view display time remaining and setup and configuration information as it is being entered.

The step of controlling the signal comprises incorporating a real time clock in the microcontroller 25 and using the real time clock for controlling timing of the viewing screen control method, using a memory device for storage, and using an operating program to keep track of user passwords and privileges. A backup battery 29 may be used to supply operating power to the clock.

Setup may be accomplished by running a word processor/text editor on the computer 30 and then entering a unique key sequence on the computer keyboard 34 or alternately on the connected keypad 34A. The invention then sends keyboard codes to the computer which will be received and displayed by the word processor as menus and status displays on the viewing display 33 or on the connected monitoring display 18. Keys pressed on the keyboard or keypad are received by the microcontroller 25 and provide input to the setup and password functions.

In FIGS. 4 and 5, the step of controlling the blue light signal comprises using a manual switching mechanism to allow controlling the signal as seen in FIG. 5, preferably the manual switching mechanism comprises using a lockable key switch housed within a locked container, as shown in FIG. 4.

In FIG. 4 showing an inexpensive simplified version, the method for controlling the signal 20A comprises installing a manual switching mechanism 14 to allow controlling the signal, the manual switching mechanism may comprise a lockable key switch housed within a locked container 21A. In FIG. 5, switching on the locking key switch at a desired time reduces the blue light level VGA output from the VGA input.

When the signal is a video signal, the method for controlling the signal may comprises using a video card inside the electronic device or inside the visual display controls, when the viewing screen includes differential color controls, to act as a video device driver for the video display.

In FIGS. 7 and 8, in a flat panel display consisting of a controller IC connected to the input ports and the LCD panel including a microprocessormicrocontroller connected with a keypad and a flat panel controller with an on screen display character generator, is for the present invention to provide a real time clock IC (RTC) with a backup battery added to the flat panel and the microcontroller routines can be changed to incorporate both password security features for parental control and determine whether or not the display should be dimmed, wherein the Microcontroller can reconfigure the settings of the color gain values within the SAA6703 controller so that the blue levels can be lowered after a certain time in the evening.

In FIG. 11, a flow diagram shows the operational steps of another software embodiment of the present invention for dimming a blue light in a display by making changes to the device drivers or operating system to intercept or alter display pixel values to lower the blue content by identifying all places in software where the actual values are being written to the display memory or memory control hardware and inserting a program.

It is understood that the preceding description is given merely by way of illustration and not in limitation of the invention and that various modifications may be made thereto without departing from the spirit of the invention as claimed.

### APPENDIX

Higuchi, S., Motohashi, Y., Yang, L. Ahara, M., Kaneko, Y. (2003). Effects of VDT tasks with a bright display at night on melatonin, core temperature, heart rate and sleepiness. Journal of Applied Physiology
Pauly, S. (2004). Lighting for the human circadian clock; recent research indicates that lighting has become a public health issue. Medical Hypothesis.

What is claimed is:

1. A viewing screen control device comprising a means for controlling a signal from an electronic device to a viewing screen to control display levels of the viewing screen by limiting specific colors that affect human sleep patterns.

2. The viewing screen control device of claim 1 wherein the means for controlling the signal comprises a blue color limiting means to allow normal production of melatonin by a user.

3. The viewing screen control device of claim 1 wherein the means for controlling the signal to the viewing screen comprises a means for switching the signal.

4. The viewing screen control device of claim 1 wherein the means for controlling the signal to the viewing screen comprises a means for attenuating the signal.

5. The viewing screen control device of claim 1 further comprising a means for controlling timing of the means for controlling the signal to the viewing screen.

6. The viewing screen control device of claim 1 wherein the means for controlling the signal to the viewing screen comprises a programmable signal controlling circuitry within a locked container secured to the electronic device or the viewing screen, the signal controlling circuit altering the signal.

7. The viewing screen control device of claim 6 wherein the signals are video signals and the programmable signal controlling circuitry comprises a video switching circuitry controlled by a microcontroller to provide analog switching and attenuation of the video signals.

8. The viewing screen control device of claim 7 wherein the electronic device has a VGA output port connectable to the viewing screen and the control circuitry is plugged into the VGA output port with a screw plug connection housed within a closed box with a locked lid.

9. The viewing screen control device of claim 1 wherein the electronic device is a computer having a keyboard and further comprising a connection to the keyboard to allow entry of installation and configuration data and login user selection and password and to provide operating power to the viewing screen control device.

10. The viewing screen control device of claim 1 wherein the electronic device is a computer having a USB keyboard and further comprising a USB port connection to the keyboard to allow entry of installation and configuration data and login user selection and password.

11. The viewing screen control device of claim 1 further comprising a keypad for entry of password information and a display to display time remaining and setup and configuration information as it is being entered.

12. The viewing screen control device of claim 1 wherein the means for controlling the signal comprises a real time clock for controlling timing of the viewing screen control device, a memory device, and an operating program to keep track of user passwords and privileges.

13. The viewing screen control device of claim 12 further comprising a backup battery to supply operating power to the clock.

14. The viewing screen control device of claim 1 wherein the means for controlling the signal comprises a manual switching mechanism to allow controlling the signal.

15. The viewing screen control device of claim 14 wherein the manual switching mechanism comprises a lockable key switch housed within a locked container.

16. The viewing screen control device of claim 1 wherein the signal is a video signal and the means for controlling the signal comprises a video card to act as a video device driver for the video display.

17. The viewing screen control device of claim 1 wherein the viewing screen includes differential color controls and the means for controlling the signal is incorporated in the viewing screen.

18. The viewing screen control device of claim 1 wherein the viewing screen comprises a display consisting of a controller IC connected to the input ports and the LCD panel includes a microcontroller connected with a keypad and a flat panel controller with an on screen display character generator and further comprising a real time clock IC (RTC) with a backup battery added to the flat panel, and microcontroller routines to determine whether or not the display should be dimmed and reconfiguring settings of color gain values to lower blue light levels after a certain time in the evening.

19. The viewing screen control device of claim 1 wherein the viewing screen comprises a display consisting of a controller IC connected to the input ports and further comprises a microcontroller connected to the input ports and microcontroller routines to dim or restore the display after receiving control signals from the input ports.

20. The viewing screen control device of claim 19 wherein the input port control signals are received on the serial control interface through the VESA Data Display Channel Command Interface (DDC/CI).

21. The viewing screen control device of claim 1 further comprising a software method to change device drivers to intercept or alter display pixel values to lower the blue content by identifying all places in software where actual values are written to a display memory or memory control hardware.

22. The viewing screen control device of claim 1 further comprising software to change an operating system to intercept or alter display pixel values to lower the blue content by identifying all places in software where actual values are written to a display memory or memory control hardware.

23. The viewing screen control device of claim 1 wherein existing video display controllers contain integrated or external digital to analog converters that convert the binary values of color levels to analog levels output on a VGA or an analog section of a DVI connector and the digital to analog converters contain high speed memory devices for a color palette that can quickly and without glitching translate values and comprising software to alter the memory to change the analog signal levels that are output for each digital value input by changing the values in the digital to analog converters to output lower analog signal levels for blue light.
